(19) United States
(12) Patent Application Publication
(10) Pub. No.: US 2015/0113533 A1
(43) Pub. Date: Apr. 23, 2015

(54) CLOUD SYSTEM FOR MANAGING CREATION AND DISTRIBUTION OF TEMPLATES OF VIRTUAL MACHINES AND METHOD THEREOF

(71) Applicant: POWER-ALL NETWORKS LIMITED, Shatin (HK)

(72) Inventors: STEVE LAP WAI HUI, Hong Kong (HK); MENG-MING HUANG, Hong Kong (CN); JUN LV, Hong Kong (CN); JIAN-DONG QIN, Hong Kong (CN)

(21) Appl. No.: 14/517,915

(22) Filed: Oct. 19, 2014

(30) Foreign Application Priority Data
Oct. 18, 2013 (CN) 201310490127.1

(51) Int. Cl. G06F 9/455; G06F 9/445

(52) U.S. Cl. CPC G06F 9/45533; G06F 8/61; G06F 8/63
USPC 718/1

(57) ABSTRACT

A method for managing creation and distribution of templates of virtual machines through a cloud system includes a template creator creating the template, and a template user purchasing and installing the template. The template creator creates the template by registering an account, inputting basic information of the template, purchasing a virtual machine or using a virtual machine of the template creator to create the template, creating a template design, creating the template on the virtual machine according to the template design, and uploading the template to a template library. The template user purchases and installs the template by purchasing the virtual machine, obtaining identification information of the template and of the corresponding Internet data center from an order form, obtaining a download link of the template according to the identification information, downloading the template to the corresponding Internet data center, and installing the template on the purchased virtual machine.

### FIELD

The present disclosure relates to virtual machines, and more particularly to a cloud system and a method thereof for managing creation and distribution of templates for the virtual machines.

### BACKGROUND

Generally, templates of virtual machines can be created and sold to customers. The templates may have different formats.

### BRIEF DESCRIPTION OF THE DRAWINGS

Implementations of the present technology will now be described, by way of example only, with reference to the attached figures.

FIG. 1 is a diagrammatic view of an exemplary embodiment of a template creator creating a template of a virtual machine.

FIG. 2 is a diagrammatic view of an exemplary embodiment of a template user purchasing and installing the template on the virtual machine.

FIG. 3 is a flowchart of an exemplary embodiment of a method of creating the template.

FIG. 4 is a flowchart of an exemplary embodiment of a method of purchasing and installing the template.

FIG. 5 is a flowchart of an exemplary embodiment of a method of authorizing an operating system of the virtual machine to run the template.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

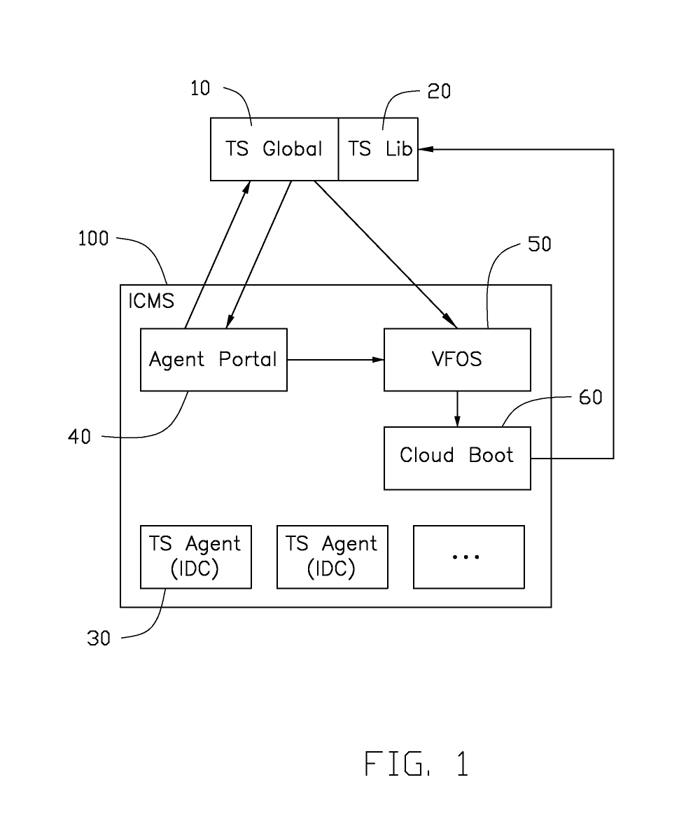

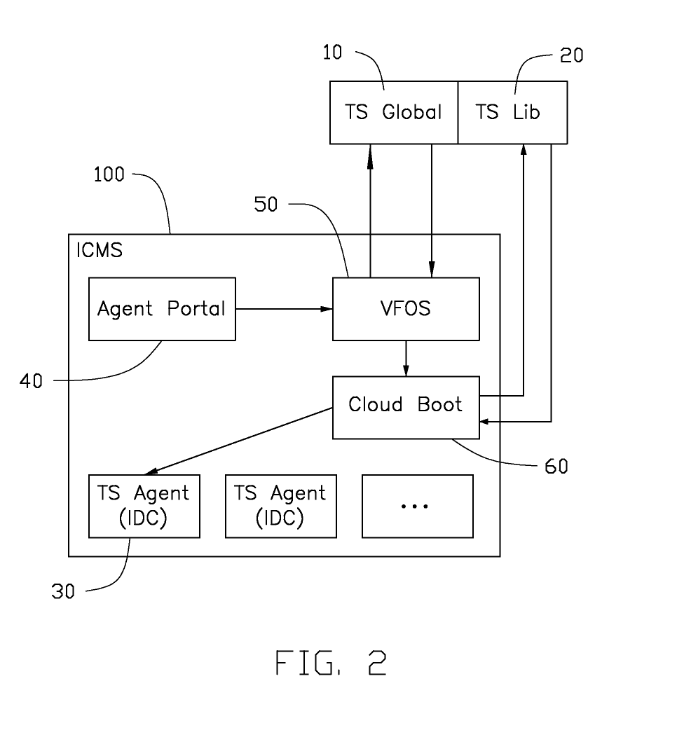

FIG. 1 and FIG. 2 illustrate an exemplary embodiment of a cloud system for managing creation and distribution of templates for virtual machines. The templates can be created by a first user (hereinafter “the template creator”), and the templates can be purchased by a second user (hereinafter “the template user”). The system can include a template service global control center (hereinafter “the TS Global”) 10, a template service library (hereinafter “the TS Lib”) 20, and a plurality of template service agents (hereinafter “the TS Agents”) 30. The TS Global 10 is a main control center of the cloud system. The TS Lib 20 can store the created templates. Each TS Agent 30 can serve as an Internet data center (IDC). When the template user purchases the template, the template can be downloaded to the corresponding TS Agent 30.

The cloud system can further include a plurality of inter-cloud management systems (ICMS) 100. Each ICMS 100 can be a cloud environment of an operator. Each ICMS 100 can be coupled to the TS Global 10 and the TS Lib 20 through the cloud system, and each TS Agent 30 can serve as an IDC of the corresponding ICMS 100. Thus, the template creator of a first ICMS 100 (as shown in FIG. 1) can create a template, and the template user of a second ICMS 100 (as shown in FIG. 2) can purchase and install the template. Therefore, templates created and purchased in the cloud system can have a same format, and purchase and installation of the templates through the cloud system can be simplified.

FIG. 1 illustrates an exemplary embodiment of the template creator creating the template. The template creator can first register an account on a cloud service and transaction platform (hereinafter “the Agent Portal”) 40. The Agent Portal 40 can be a website for selling virtual machines, templates of the virtual machines, and the like.

After the account is approved by the Agent Portal 40, the template creator can input basic information of the template to the TS Global 10. The basic information can include a name of the template, a description of the template, a price of the template, and the like. The TS Global 10 can determine whether the template creator has the virtual machine for creating the template. If the template creator does not have the virtual machine, the TS Global 10 can instruct the template creator to purchase the virtual machine on the Agent Portal 40. The template creator can create a template design for the virtual machine on the TS Global 10. After the template design is created, the TS Global 10 can send the virtual machine and the template design to a virtual facilities operating system (hereinafter “the VFOS”) 50. The VFOS 50 can control the virtual machine to create the template according to the template design.

To create the template, the VFOS 50 can send out a message for creating the template and control the virtual machine to restart. After the virtual machine restarts, a specialized basic input/output system (hereinafter “the Cloud Boot”) 60 can receive the message. After receiving the message, the Cloud Boot 60 can perform a disk dump on a second partition of the virtual machine, and create an image file of a hard disk of the virtual machine. In at least one embodiment, the template is the image file created by the Cloud Boot 60, and the Cloud Boot 60 can upload the template to the TS Lib 20.

FIG. 2 illustrates an exemplary embodiment of the template user purchasing and installing the template. The template user can purchase the template by purchasing the corresponding virtual machine in the Agent Portal 40. After the virtual machine is purchased, the Agent Portal 40 can send an order form of the purchased virtual machine to the VFOS 50. The order form can include identification information of the template, and of the corresponding TS Agent 30 to download the template to. The VFOS 50 can send the identification information to the TS Global 10, and the TS Global 10 can send a download link of the template to the VFOS 50 according to the identification information. In at least one embodiment, the download link can be a dynamic address including a resource hash value, a resource name, and a validity period. The VFOS 50 can send the download link to the Cloud Boot 60 to download the template. The Cloud Boot 60 can download the template from the TS Lib 20 according to the download link. When the Cloud Boot 60 attempts to download the template after the validity period has passed, the TS Lib 20 can send a message to the Cloud Boot 60 informing that the download link has expired and that the download link needs to be reacquired.

To install the template, the VFOS 50 can send out a message for installing the template and control the virtual machine to restart. After the virtual machine restarts, the Cloud Boot 60 can receive the message and download the template from the TS Lib 20 to the corresponding TS Agent 30 according to the download link. After the template is downloaded, the Cloud Boot 60 can install the template on the virtual machine.

Each TS Agent 30 and the TS Lib 20 can include a GLUSTERFS system. After the template is created, the Cloud Boot 60 can upload the template to an FTP server of the TS Lib 20. After the template is downloaded to the TS Agent 30, the template can be synced with the template in the FTP server of the TS Lib 20 through the GLUSTERFS system. When the template is updated in the TS Lib 20, the updates can be synced to the template in the TS Agent 30 through the GLUSTERFS system.

The template can include an authorization program. When the template includes the authorization program, an operating system of the virtual machine requires authorization to run the template. After the virtual machine is started, the authorization program of the template can be executed. The authorization program can request an authorization system of the operating system to authorize the operating system. After the operating system is authorized, the authorization program can request the TS Global 10 to sign a subscription of the template. After the subscription is signed, the TS Global 10 can uninstall the authorization program from the template. In at least one embodiment, the operating system can be WINDOWS, the authorization program can be MICROSOFT SPLA, and the authorization system can be the KMS SERVER of MICROSOFT.

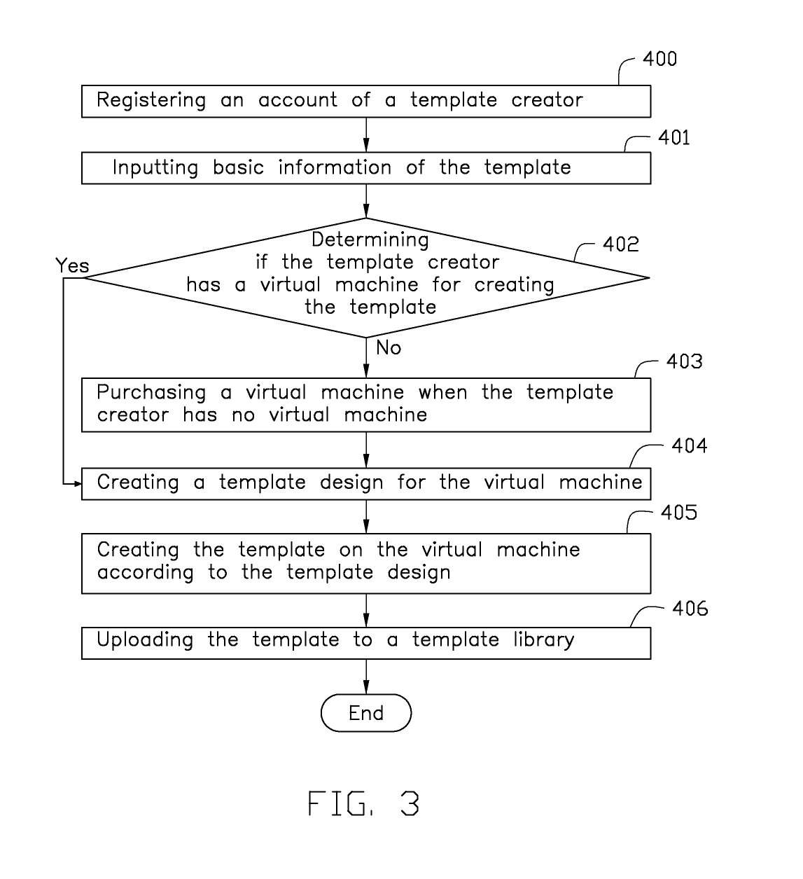

FIG. 3 illustrates a flowchart of an exemplary embodiment of a method for creating a template of a virtual machine. The example method is provided by way of example, as there are a variety of ways to carry out the method. The method described below can be carried out using the configurations illustrated in FIG. 1, for example, and various elements of the figure are referenced in explaining the example method. Each block shown in FIG. 3 represents one or more processes, methods, or subroutines carried out in the example method. Additionally, the illustrated order of blocks is by example only, and the order of the blocks can be changed. The example method can begin at block 400.

At block 400, a template creator can register an account for creating a template. The account can be verified.

At block 401, the template creator can input basic information of the template. The basic information can include a name of the template, a description of the template, a price of the template, and the like.

At block 402, whether the template creator has a virtual machine for creating the template can be determined. If the template creator does not have the virtual machine, block 403 can be implemented. If the template creator has the virtual machine, block 404 can be implemented.

At block 403, the template creator can purchase the virtual machine.

At block 404, the template creator can create a template design for the virtual machine.

At block 405, the template can be created on the virtual machine according to the template design.

At block 406, the template can be uploaded to a template library to store the template.

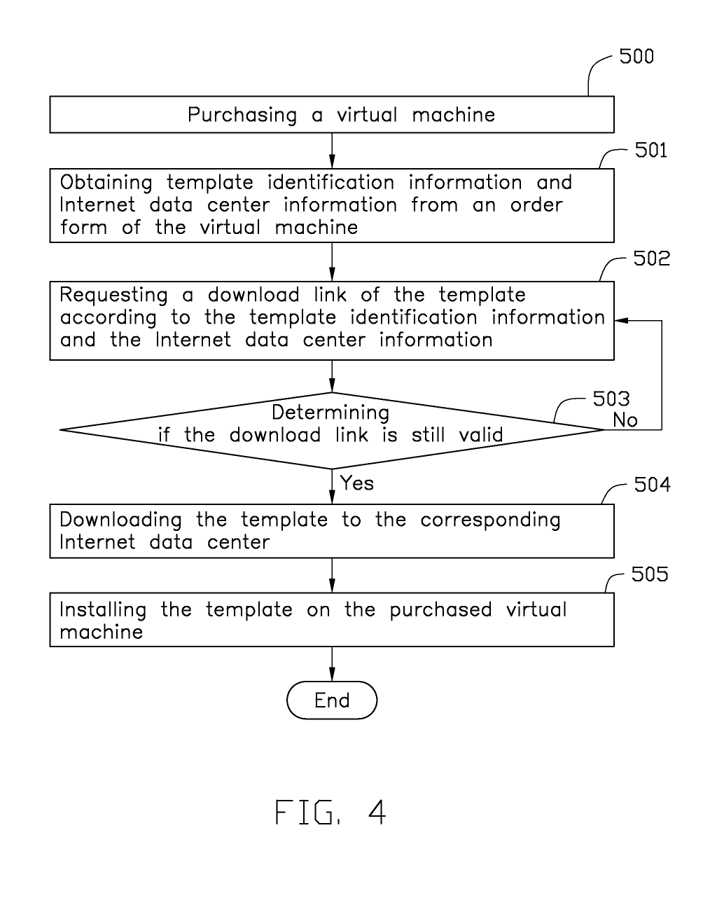

FIG. 4 illustrates a flowchart of an exemplary embodiment of a method for installing a template of a virtual machine. The example method is provided by way of example, as there are a variety of ways to carry out the method. The method described below can be carried out using the configurations illustrated in FIG. 2, for example, and various elements of the figure are referenced in explaining the example method. Each block shown in FIG. 4 represents one or more processes, methods, or subroutines carried out in the example method. Additionally, the illustrated order of blocks is by example only, and the order of the blocks can be changed. The example method can begin at block 500.

At block 500, a template user can purchase a virtual machine.

At block 501, identification information of a template and of a corresponding Internet data center can be obtained from an order form of the purchased virtual machine.

At block 502, a download link corresponding to the identification information can be obtained to download the template from a template library.

At block 503, whether the download link is still valid is determined. If the download link is not valid, block 502 can be implemented. If the download link is still valid, block 504 can be implemented.

At block 504, the template can be downloaded to the corresponding Internet data center.

At block 505, the template can be installed on the purchased virtual machine.

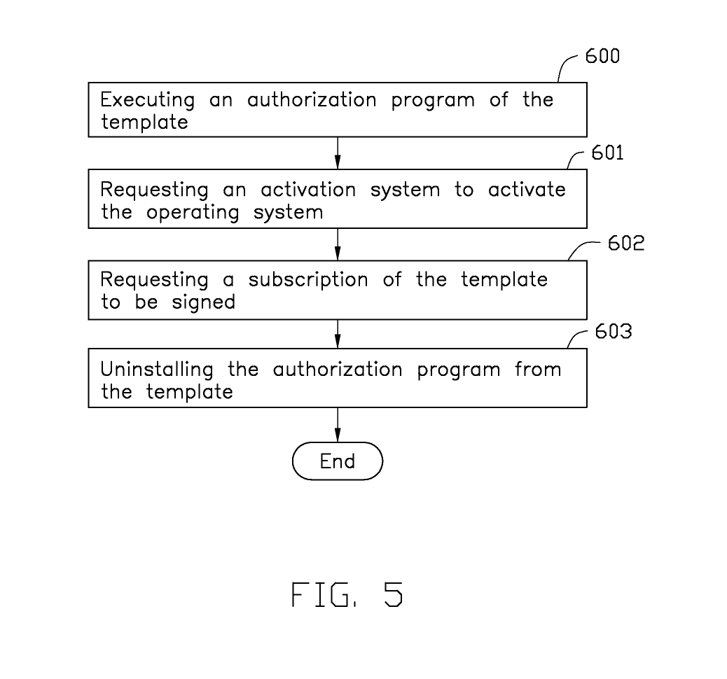

FIG. 5 illustrates a flowchart of an exemplary embodiment of a method for authorizing an operating system of a virtual machine to run a template. The example method is provided by way of example, as there are a variety of ways to carry out the method. Each block shown in FIG. 5 represents one or more processes, methods, or subroutines carried out in the example method. Additionally, the illustrated order of blocks is by example only, and the order of the blocks can be changed. The example method can begin at block 600.

At block 600, an authorization program of the template can be executed.

At block 601, the authorization program can request an activation system of the operating system to activate the operating system. The operating system can be activated by the activation system.

At block 602, a subscription of the template can be signed.

At block 603, the authorization program can be uninstalled.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A method for managing creation and distribution of templates of virtual machines through a cloud system comprising:
creating the template comprising:
registering an account of a template creator;
inputting basic information of the template;
determining if the template creator has a virtual machine for creating the template;
purchasing a virtual machine if the template creator has no virtual machine;
creating a template design for the virtual machine;
creating the template on the virtual machine according to the template design; and
uploading the template to a template library of a template service system; and
installing the template comprising:
purchasing the virtual machine owned by the template creator;
obtaining template identification information and Internet data center information from an order form of the virtual machine;
obtaining a download link of the template from a template global center of the template service system according to the template identification information and the Internet data center information;
downloading the template to a corresponding Internet data center; and
installing the template on the purchased virtual machine.

2. The method as in claim 1 further comprising authorizing an operating system of the purchased virtual machine to run the template created by the template creator when the template comprises an authorization program.

3. The method as in claim 1, wherein creating the template on the template creator's virtual machine according to the template design comprises:
outputting a message of creating the template;
controlling the virtual machine to restart;
performing a disk dump on a second partition of the virtual machine according to the message; and
creating an image file of a hard disk of the virtual machine.

4. The method as in claim 3, wherein uploading the template to the template library comprises uploading the image file to an FTP server of the template library.

5. The method as in claim 1, wherein downloading the template comprises:
determining whether a validity period of the download link has passed;
sending a message informing that the download link has expired when the validity period has passed; and
downloading the template when the validity period has not passed.

6. The method as in claim 2, wherein authorizing the operating system comprises steps of:
executing the authorization program;
requesting an activation system to activate the operating system;
after the operating system is activated, requesting a subscription of the template to be signed; and
after the subscription of the template is signed, uninstalling the authorization program from the template.

7. A cloud system for managing creation and distribution of templates of virtual machines comprising:
a template service global control center configured to allow a template creator to create the template, and allow a template user to purchase and install the template;
a template service library configured to store the templates after the templates are created, and provide the templates for download when the templates are purchased;
a plurality of template service agents, each template service agent serving as an Internet data center and configured to temporarily store the downloaded templates before installing the templates, and when the templates are updated in the template service library, configured to sync the updates to the installed templates;
a cloud service and transaction platform configured to provide the virtual machines and templates for purchase;
a virtual facilities operating system configured to control creation of the template on the virtual machine of the template creator, and further configured to control installation of the template on the purchased virtual machine of the template user; and
a specialized basic input/output system (BIOS) of the virtual machine configured to create the template on the virtual machine of the template creator, and further configured to install the template on the purchased virtual machine of the template user.

8. The system as in claim 7, wherein the cloud service and transaction platform, the virtual facilities operating system, the specialized BIOS, and the plurality of template service agents operate in a plurality of inter-cloud management systems;
each inter-cloud management system is a cloud environment of an operator, and each inter-cloud management system is coupled to the template service global control center and the template service library through the cloud system; and each template service agent serves as the Internet data center of the corresponding inter-cloud management system.

9. The system as in claim 8, wherein the cloud service and transaction platform is a website.

10. The system as in claim 9, wherein the template creator registers an account on the cloud service and transaction platform to create the template; and the account is registered after the cloud service and transaction platform approves the account.

11. The system as in claim 10, wherein the template creator inputs basic information of the template to the template service global control center; the template service global control center determines whether the template creator has the virtual machine to create the template; the virtual machine is purchased on the cloud service and transaction platform when the template creator does not have the virtual machine.

12. The system as in claim 11, wherein the template creator creates a template design of the template on the template service global control center; after the template design is created, the template service global control center transfers the template design to the virtual facilities operating system, and the virtual facilities operating system controls the specialized BIOS of the virtual machine to create the template according to the template design.

13. The system as in claim 12, wherein the template user purchases the template creator's template by purchasing the corresponding virtual machine on the cloud service and transaction platform; the virtual facilities operating system receives an order form of the purchased virtual machine from the cloud service and transaction platform; the virtual facilities operating system obtains identification information of the template and identification information of the corresponding template service agent from the order form, and sends the identification information of the template and the corresponding template service agent to the template service global control center; the template service global control center sends a download link of the template corresponding to the identification information of the template and the corresponding template service agent to the virtual facilities operating system; and the specialized BIOS of the virtual machine downloads the template from the template service library to the corresponding template service agent according to the download link.

14. The system as in claim 11, wherein the basic information of the template comprises a name of the template, a description of the template, and a price of the template.

15. The system as in claim 13, wherein the download link of the template is a dynamic address; the dynamic address comprises a resource hash value, a resource name, and a validity period; and when the specialized BIOS attempts to download the template after the validity period has passed, the template service global control center sends a message to the specialized BIOS informing that the download link has expired and that the download link needs to be reacquired.

16. The system as in claim 12, wherein to create the template, the virtual facilities operating system outputs a message of creating the template and controls the virtual machine to restart; after the virtual machine restarts, the specialized BIOS receives the message and performs a disk dump on a second partition of the virtual machine, and creates an image file of a hard disk of the virtual machine; outputting a message of creating the template; the image file is uploaded to an FTP server of the template library.

17. The system as in claim 16, wherein each template service agent and the template service library comprise a GLUSTERFS system; after the template is created, the specialized BIOS uploads the template to the FTP server of the template service library; after the template is downloaded to the template service agent, the template is synced with the template in the FTP server of the template service library through the GLUSTERFS system; and when the template is updated in the template service library, the updates are synced through the GLUSTERFS system to the template in the template service agent.

18. The system as in claim 16, wherein the created template comprises an authorization program for authorizing an operating system of the virtual machine to run the template, and the authorization program is uninstalled after the operating system is authorized.

19. The system as in claim 18, wherein the operating system is WINDOWS, and the authorization program is MICROSOFT SPLA; when the virtual machine is turned on, the MICROSOFT SPLA requests the KMS SERVER of WINDOWS to activate the operating system; after the operating system is activated, the MICROSOFT SPLA can request the template service global control center to sign a subscription of the template; and after the subscription is signed, the template service global control center uninstalls the MICROSOFT SPLA.
